(19) United States
(12) Patent Application Publication
(10) Pub. No.: US 2014/0363668 A1
(43) Pub. Date: Dec. 11, 2014

(54) AQUEOUS DISPERSION TYPE ADHESIVE

(71) Applicant: HENKEL AG & CO. KGAA, Duesseldorf (DE)

(72) Inventors: Chiho Fujita, Osaka (JP); Hitoshi IKEDA, Osaka (JP); Takehiro IMANISHI, Osaka (JP)

(21) Appl. No.: 14/469,068

(22) Filed: Aug. 26, 2014

Related U.S. Application Data
(63) Continuation of application No. PCT/JP2013/055760, filed on Feb. 25, 2013.

(30) Foreign Application Priority Data
Feb. 27, 2012 (JP) 2012-040497

(51) Int. Cl. C09J 131/04; C08K 5/11

(52) U.S. Cl. CPC C09J 131/04; C08K 5/11
USPC 428/355 EN; 524/311

(57) ABSTRACT

The present invention provides an aqueous dispersion type adhesive which is excellent in adhesion and is accurately ejected through a nozzle without fouling the nozzle when the adhesive is applied by a nozzle coater, and a paper product obtainable by applying the aqueous dispersion type adhesive. An aqueous dispersion type adhesive including an ethylene-vinyl acetate based modified emulsion and a plasticizer, the plasticizer containing an acetyl group-containing compound, is excellent in adhesive strength and does not cause fouling of a nozzle when the adhesive is ejected through the nozzle of a nozzle coater. When the acetyl group-containing compound contains triacetin, adhesion between a paper and a metal foil is improved, and thus fouling of a nozzle is less likely to occur. Moreover, when the ethylene-vinyl acetate based modified emulsion contains a modification having a carboxyl group attached thereto, fouling of a nozzle is much less likely to occur, preferably.

### CROSS-REFERENCE TO RELATED APPLICATION

This application is a continuation of International Patent Application No. PCT/JP2013/055760 filed Feb. 25, 2013, which claims priority to Japanese Patent Application No. 2012-040497 filed Feb. 27, 2012, the contents of both of which are incorporated herein by reference.

### FIELD OF THE INVENTION

The present invention relates to an aqueous dispersion type adhesive, and particularly to an aqueous dispersion type adhesive which is employed in paper processing applications, and a paper product obtainable by applying the aqueous dispersion type adhesive.

### BACKGROUND OF THE INVENTION

Heretofore, there have widely been used, as adhesives, an “ethylene-vinyl acetate copolymer resin emulsion” obtained by copolymerizing vinyl acetate with ethylene, and a vinyl acetate resin emulsion obtained by polymerizing a vinyl acetate monomer alone using a water-soluble polymer such as polyvinyl alcohol as a protective colloid.

While an ethylene-vinyl acetate based adhesive is useful in the fields of woodworking and paper processing, mixing with other emulsions and modification of the ethylene-vinyl acetate copolymer resin emulsion are often studied so as to further improve the performances according to the applications and purposes.

JP 2001-049224 discloses an adhesive including an aqueous emulsion obtained by polymerizing ethylene, vinyl acetate, vinyl chloride, and acrylic acid. It is possible to exemplify, as applications of the adhesive according to the same literature, woodworking and packaging applications (paper/paper, paper/aluminum foil) (see Table 1 in [0034], and [0023] of JP 2001-049224).

JP 2000-119621 discloses an aqueous adhesive composed of a resin aqueous dispersion which is obtained by emulsion polymerization of a polymerizable unsaturated monomer using, as a protective colloid, an aqueous polymer solution obtainable by polymerizing a carboxyl group-containing polymerizable unsaturated monomer in an aqueous solution of a saponified ethylene-vinyl acetate copolymer. The same literature also discloses that the adhesive is useful as an adhesive for paper tube (see claim 2, [0001] of JP 2000-119621).

JP 2003-064335 discloses an adhesive including three components of an ethylene-vinyl acetate copolymer emulsion, an acrylic resin based emulsion, and a water-soluble acrylic polymer. The same literature also discloses that the adhesive including these three components is useful for bonding between a front cover of a wallpaper and a lining paper (see claim 1, [0001], and Table 2 in [0056] of JP 2003-064335).

While the aqueous adhesives of JP 2001-049224, JP 2000-119621 and JP 2003-064335 are useful for paper applications, it is required for an adhesive for paper to be excellent in not only bonding between papers but also bonding between different materials, for example, bonding between a paper and a metal foil. The aqueous adhesives of these literatures have improved adhesive strength, but are still insufficient in adhesive strength taking account of high performances required by users in recent days.

It is also required for the adhesive for paper to improve, in addition to the adhesive strength, production efficiency of a paper product. When the adhesive is applied to a paper (a metal foil, a plastic film, or a woody material) as an adherend or as a base material at a high speed so as to improve production efficiency, a nozzle coater may be sometimes employed. When an ethylene-vinyl acetate based adhesive is applied by the nozzle coater, the adhesive may sometimes fail to be stably ejected through the nozzle. When the aqueous adhesives of JP 2001-049224, JP 2000-119621 and JP 2003-064335 are applied by a nozzle coater, it may be difficult to apply to a portion where the adhesive is to be applied, and thus causing fouling of the nozzle.

### SUMMARY OF THE INVENTION

The present invention has been made in view of these circumstances, and an object of the present invention is to provide an aqueous dispersion type adhesive which is excellent in adhesion (or adhesive property) and is accurately ejected through a nozzle without fouling the nozzle when the adhesive is applied by a nozzle coater, and a paper product obtainable by applying the aqueous dispersion type adhesive.

The present inventors have intensively studied and found that an adhesive obtained by adding a specific plasticizer to a modified ethylene-vinyl acetate copolymer emulsion is excellent in adhesion (or adhesive property) and is also accurately ejected through a nozzle of a nozzle coater without fouling the nozzle, and thus completing the present invention.

That is, the present invention provides, in an aspect, an aqueous dispersion type adhesive including a modified ethylene-vinyl acetate copolymer based emulsion and a plasticizer, wherein the plasticizer contains an acetyl group-containing compound.

The present invention provides, in an embodiment, the aqueous dispersion type adhesive, wherein the acetyl group-containing compound contains triacetin.

The present invention provides, as another embodiment, the aqueous dispersion type adhesive, wherein the plasticizer further contains a benzoic acid ester.

The present invention provides, as further another embodiment, the aqueous dispersion type adhesive, wherein the ethylene-vinyl acetate based modified emulsion contains a modification in which a C═O-containing functional group is attached to an ethylene-vinyl acetate copolymer.

The present invention provides, as a preferred embodiment, the aqueous dispersion type adhesive, wherein the ethylene-vinyl acetate based modified emulsion contains a modification in which a carboxyl group is attached to an ethylene-vinyl acetate copolymer.

The present invention provides, as a more preferred embodiment, the aqueous dispersion type adhesive, wherein the modified ethylene-vinyl acetate copolymer has a glass transition temperature of 10° C. or lower.

The present invention provides, as a most preferred embodiment, the aqueous dispersion type adhesive, which is used for paper processing.

The present invention provides, as another aspect, a paper product obtainable by using the above aqueous dispersion type adhesive.

The aqueous dispersion type adhesive according to the present invention includes a modified ethylene-vinyl acetate copolymer based emulsion and a plasticizer, and the plasticizer contains an acetyl group-containing compound, and is therefore excellent in adhesive strength and when the adhesive is ejected through a nozzle of a nozzle coater upon application, the adhesive does not cause fouling of the nozzle.

In the aqueous dispersion type adhesive according to the present invention, when the acetyl group-containing compound contains triacetin, adhesion (or adhesive property) between a paper and aluminum is improved and thus fouling of the nozzle is less likely to occur.

In the aqueous dispersion type adhesive according to the present invention, when the plasticizer further contains a benzoic acid ester, fouling of the nozzle is much less likely to occur while maintaining adhesion between a paper and a paper.

In the aqueous dispersion type adhesive according to the present invention, when the ethylene-vinyl acetate based modified emulsion contains a modification in which a C═O-containing functional group is attached to an ethylene-vinyl acetate copolymer, adhesion is improved by C═O as a polar group.

In the aqueous dispersion type adhesive according to the present invention, when the ethylene-vinyl acetate based modified emulsion contains a modification in which a carboxyl group is attached to an ethylene-vinyl acetate copolymer, adhesion between a paper and aluminum is more improved, and thus fouling of the nozzle of the nozzle coater is much less likely to occur.

In the aqueous dispersion type adhesive according to the present invention, when the modified ethylene-vinyl acetate copolymer has a glass transition temperature of 10° C. or lower, the adhesive is more excellent in balance between both adhesion between papers and adhesion between a paper and aluminum.

When the aqueous dispersion type adhesive according to the present invention is used for paper processing, it is possible to efficiently produce a paper product by high-speed coating using a nozzle coater.

The paper product according to the present invention is obtainable by using the above aqueous dispersion type adhesive, and is therefore efficiently produced by high-speed coating. Since bonding between papers and bonding between a paper and other base materials (for example, a metal foil, a plastic film, or a woody material) becomes easier by excellent adhesion of the aqueous dispersion type adhesive of the present invention, paper products, especially a packaging container made of a paper is produced more efficiently, and the shape of the packaging container is not damaged by inclusion and thus is maintained over a long period.

### DETAILED DESCRIPTION OF THE INVENTION

The aqueous dispersion type adhesive according to the present invention includes a modified ethylene-vinyl acetate copolymer based emulsion and a plasticizer.

As used herein, the “aqueous dispersion type” means a state where a polymer is suspended in an aqueous medium. That is, the “aqueous dispersion type adhesive” is intrisically an adhesive in which a polymer which is insoluble (or slightly soluble) in an aqueous medium is emulsified by a protective colloid etc. and is uniformly mixed with the aqueous medium. Therefore, the aqueous dispersion type adhesive of the present invention is different from a water-soluble adhesive in which a polymer is dissolved in an aqueous medium, and is clearly distinguished therefrom.

As used herein, the “aqueous medium” refers to general water such as tap water, distilled water, or ion-exchange water, and may contain organic solvents which are soluble in the aqueous medium and also have poor reactivity with an adhesive component according to the present invention, for example, acetone and ethyl acetate etc., and also may contain a monomer, an oligomer, a prepolymer and/or a resin etc. which is/are soluble in the aqueous medium. The aqueous medium may also contain the below-mentioned various additives.

In the present invention, the ethylene-vinyl acetate based modified emulsion means that an ethylene-vinyl acetate copolymer emulsion is modified by attaching a specific functional group to the copolymer.

There is no particular limitation on the method for producing the ethylene-vinyl acetate based modified emulsion, as long as it is possible to obtain an ethylene-vinyl acetate based modified emulsion capable of obtaining the objective aqueous dispersion type adhesive of the present invention, and the production method thereof includes, for example:

(1) a method in which ethylene, vinyl acetate, and “other polymerizable monomers” are copolymerized, and

(2) a method in which an ethylene-vinyl acetate copolymer emulsion is previously produced and then a functional group is attached to the copolymer.

By copolymerizing the “other polymerizable monomers” with the ethylene-vinyl acetate copolymer emulsion, a specific functional group possessed by the “other polymerizable monomers” is attached, and thus producing the objective ethylene-vinyl acetate based modified emulsion.

There is no particular limitation on “other polymerizable monomers”, as long as they are polymerizable monomers having an ethylenic double bond, and are preferably monomers having a C═O containing functional group. Therefore, the ethylene-vinyl acetate based modified emulsion is preferably modified by attaching a C═O containing functional group. A carbonyl group is also included in the C═O-containing functional group as used herein.

The C═O-containing functional group is not particularly limited as long as it is a C═O containing functional group and the objective aqueous dispersion type adhesive of the present invention can be obtained, and includes, for example, a carbonyl group (—CO—), an aldehyde group (—CHO), a carboxyl group (—COOH), an ester group (—COO—) and an amide group (—CONH—) derived from carboxylic acid, an acid anhydride group (—COOCO—), and an acid chloride group (—COCl).

In the present invention, the monomer having a C═O-containing functional group is preferably a monomer having at least one selected from a carboxyl group, an ester group, an amide group, an acid chloride group, and an acid anhydride group. As used herein, since the “C═O containing functional group” means a functional group which is further attached so as to modify the ethylene-vinyl acetate copolymer emulsion, the “C═O containing functional group” does not include an ester group which is based on vinyl acetate and contained in the ethylene-vinyl acetate copolymer emulsion itself.

Examples of the monomer having a carboxyl group include acrylic acid and methacrylic acid.

Examples of the monomer having an ester group include methyl acrylate, ethyl acrylate, propyl acrylate, butyl acrylate, 2-ethylhexyl acrylate, 2-hydroxyethyl acrylate, methyl methacrylate, ethyl methacrylate, propyl methacrylate, butyl methacrylate, 2-ethylhexyl methacrylate, and 2-hydroxyethyl methacrylate.

Examples of the monomer having an amide group include acrylamide and methacrylamide.

Examples of the monomer having an acid chloride group include vinyl propionate and vinyl versatate.

Examples of the monomer having an acid anhydride group include acetic anhydride, maleic anhydride, and phthalic anhydride.

These monomers having a C═O-containing functional group may be used alone, or plural kinds thereof may be used. The C═O as a polar group has a function of enhancing adhesion of the adhesive.

In the present invention, these “other polymerizable monomers” are preferably monomers having a carboxyl group, such as acrylic acid and methacrylic acid. It is possible to obtain an ethylene-vinyl acetate based modified emulsion (or ethylene-vinyl acetate based carboxyl modified emulsion) having a carboxyl group by polymerizing acrylic acid and/or methacrylic acid together with ethylene and vinyl acetate. Adhesion of the modified emulsion to a metal is improved by an electrostatic interaction between carboxyl groups and metal such as aluminum or tin. It also becomes possible to accurately apply the modified emulsion having a carboxyl group even by a nozzle coater since compatibility of the modified emulsion with the below-mentioned plasticizer is improved.

It is possible to use a commercially available product as the modified ethylene-vinyl acetate copolymer based emulsion having a carboxyl group. Examples thereof include SUMIKAFLEX S456 (trade name) manufactured by Sumika Chemtex Co., Ltd.; and POLYSOL AD21 and POLYSOL AD11 (trade name) manufactured by Showa Denko K.K.

The ethylene-vinyl acetate based modified emulsion can be usually produced by emulsion polymerization. The emulsion polymerization is radical polymerization using an emulsifier in water as a medium, and the ethylene-vinyl acetate based modified emulsion can be obtained according to an already-known procedure of the emulsion polymerization. It is preferred to optionally add an alkali after the emulsion polymerization.

In the emulsion polymerization, it is preferred to contain, as a protective colloid, polyvinyl alcohol (hereinafter referred to as “PVA”) in the amount of 1 to 15 parts by weight, and particularly 1.5 to 10 parts by weight, based on 100 parts by weight of the solid content of the modified emulsion. When the amount of the PVA is more than 15 parts by weight, adhesion (or adhesive property) to a paper may become insufficient. The PVA is preferably added as the protective colloid in producing the modified emulsion by the emulsion polymerization, or the PVA is not used during the emulsion polymerization and may also be added to the modified emulsion after the polymerization.

It is possible to use, as the PVA in the present invention, materials (or substances) which are usually used as a PVA. For example, the average polymerization degree is from 200 to 4,500 and also the saponification degree is not particularly limited, and completely saponified PVA and partially saponified PVA with the saponification degree of 65 to 95% are usually used. It is also possible to use PVA which is modified with an acetoacetyl group, a sulfone group, a carboxyl group, or an amide group, or copolymerized with an olefin.

It is also possible to use a combination with an emulsifying dispersant except for the PVA in the present invention.

Examples of the emulsifying dispersant except for the PVA include water-soluble polymers such as methyl cellulose and hydroxyethyl cellulose; nonionic surfactants such as polyoxyethylene alkyl ether, polyoxyethylene alkyl phenyl ether, and polyoxyethylene-polyoxypropylene block copolymer; and anionic surfactants such as laurylsulfuric acid ester and alkylbenzene sulfonate. Among these emulsifying dispersants, the nonionic surfactants such as polyoxyethylene alkyl phenyl ether and polyoxyethylene-polyoxypropylene block copolymer are preferable.

The modified emulsion of the present invention can be produced by polymerizing using a conventional radical initiator. It is possible to use, as the radical initiator, for example, organic peroxides such as hydrogen peroxide and t-butyl hydroperoxide; and persulfates such as ammonium persulfate and potassium persulfate. It is also possible to use a redox catalyst in which a radical initiator is used in combination with a reducing agent such as sodium formaldehyde sulfoxylate. Among these radical initiators, the persulfates such as ammonium persulfate and potassium persulfate can be preferably used. The polymerization temperature varies depending on kinds of the radical initiator to be used, and is preferably from 40 to 80° C.

A known emulsion polymerization method is used as the polymerization method of the modified emulsion in the present invention and examples thereof include, but are not limited to, a monomer incremental addition method, a collective charging method, and a double-step polymerization method.

In the present invention, a glass transition temperature of the ethylene-vinyl acetate based modified emulsion is preferably 10° C. or lower, more preferably from −10° C. to 10° C., and most preferably from 0° C. to 10° C. When the glass transition temperature of the modified emulsion is 10° C. or lower, adhesion (or adhesive property) (paper/paper, paper/aluminum) of the aqueous dispersion type adhesive is more improved.

As used herein, the “glass transition temperature” in the present specification refer to a temperature of an inflection point of a DSC curve of 5 to 10 mg of a sample, of which DSC curve is measured and obtained at a temperature rise rate of 5° C./minute using a differential scanning calorimeter (specifically, SII NanoTechnology DSC6220, manufactured by SII NanoTechnology Inc.).

A weight average molecular weight of the modified ethylene-vinyl acetate copolymer is preferably from 1×10³ to 5×10⁷ g/mol, particularly preferably from 1×10³ to 1×10⁷ g/mol, and most preferably from 1×10⁴ to 5×10⁶ g/mol. When the weight average molecular weight is within the above range, the obtained aqueous dispersion type adhesive of the present invention is excellent in balance between adhesion and coating suitability (or applicability). As used herein, the “coating suitability” refers to that an adhesive is accurately ejected in a dot shape without fouling a coater and is less likely to cause scattering, and also can be applied to an adherend in the form of dots each having a uniform size.

As used herein, the weight average molecular weight (Mw) in the present specification refers to a weight average molecular weight which is measured by a gel permeation chromatography (GPC) apparatus and is converted (or modified) using polyethylene glycol having a monodisperse molecular weight. More specifically, chromatogram of RI and UV was detected using Waters 2690, 2487, and 410. As a GPC column, TSKgel SuperMultipore PWXL, Ultrahydrogel Liner, TSKgel GMPWXL, and Ulyrahydrogel 250 (manufactured by TOSOH CORPORATION) were used.

A sample was dissolved in acetonitrile/0.1M pH 7.0 phosphoric acid buffet solution (20:80) and then allowed to flow at a flow rate of 0.6 ml/min and a column temperature of 40° C.

Using a calibration curve obtained by using three kinds, that is, an ethylene glycol (EG) solution as a standard reference material, and two kinds of PEO/PEG solutions (below-mentioned “STD-A” and “STD-B”) prepared by using seven kinds of standard polyethylene oxides (PEO)/polyethylene glycols (PEG), each having a different molecular weight, the Mw was determined. The STD-A was obtained by mixing PEO (Mw=920,000, 107,000, and 24,000) with PEG (Mw=1,500). The STD-B was obtained by mixing PEO (Mw=250,000 and 50,000) with PEG (Mw=3,000).

An average particle diameter of the ethylene-vinyl acetate based modified emulsion is preferably from 100 to 1,000 μm. When the average particle diameter is within the above range, coating suitability of the aqueous dispersion type adhesive of the present invention is improved, and thus it becomes possible to endure high-speed coating.

As used herein, a particle diameter of both components refers to a particle diameter measured by dynamic light scattering using a Nanotrac particle size analyzer.

In the present invention, the plasticizer contains an acetyl group-containing compound as one component. There is no particular limitation on the acetyl group-containing compound, as long as it has an acetyl group and also functions as the plasticizer.

Examples of the acetyl group-containing compound contained in the plasticizer include triacetin, tributyl acetylcitrate, triethyl acetylcitrate, methyl acetyl ricinoleate, diacetyl lauroyl glycerol, glycerin diacetomonolaurate, glycerin diacetomonooleate, and glycerin monoacetomonostearate.

These acetyl group-containing compounds may be used alone, or plural kinds thereof may be used. Since the acetyl group is used as a protecting group of a hydroxyl group, it is capable of protecting a carboxyl group to be attached to the ethylene-vinyl acetate based modified emulsion. The modified emulsion becomes temporarily stable by the protection of the carboxyl group.

Among these acetyl group-containing compounds, triacetin is preferable in the present invention. Since triacetin has high solubility in water as compared with other acetyl group-containing compounds (for example, tributyl acetylcitrate), it can uniformly exist in an aqueous medium of an aqueous dispersion type adhesive. In the aqueous dispersion type adhesive of the present invention, when triacetin uniformly exists in the aqueous medium, adhesion, especially adhesion between a paper and aluminum is more improved.

In the present invention, the plasticizer can contain not only the acetyl group-containing compound, but also a compound having no acetyl group. The “compound having no acetyl group” may be any compound which acts as a plasticizer, and examples thereof include compounds which are generally used as the plasticizer.

Specific examples of the “compound having no acetyl group” include:

esters such as phthalic acid ester, maleic acid ester, adipic acid ester, trimellitic acid ester, phosphoric acid ester, sebacic acid ester, and a benzoic acid ester;

polyhydric alcohols such as glycerin, ethylene glycol, and propylene glycol;

saccharides such as sucrose and sorbitol; and

organic solvents such as cellosolves.

In the present invention, the acetyl group-containing compound is preferably contained in the amount of 10 parts by weight or more based on 100 parts by weight of the entire plasticizer. When 10 parts by weight or more of the acetyl group-containing compound is contained, adhesion of the aqueous dispersion type adhesive may be improved and ejection from a nozzle coater may become stable, and thus fouling of the nozzle may be less likely to occur.

As long as the objective aqueous dispersion type adhesive of the present invention can be obtained, there is no particular limitation on timing and method of the addition of the plasticizer when the aqueous dispersion type adhesive of the present invention is produced. For example, the plasticizer may be added when the modified ethylene-vinyl acetate copolymer based emulsion is produced, and also the plasticizer may be added after producing the modified ethylene-vinyl acetate copolymer based emulsion.

The amount of the modified ethylene-vinyl acetate copolymer based emulsion (solid content) is preferably from 50 to 99 parts by weight based on 100 parts by weight of the total weight of the modified ethylene-vinyl acetate copolymer based emulsion (solid content) and the plasticizer. Preferably, the modified ethylene-vinyl acetate copolymer emulsion and the plasticizer are the major components of the aqueous dispersion type adhesive, i.e. the adhesive comprises at least 80% by weight, preferably at least 90% by weight, more preferred at least 95% by weight of the modified ethylene-vinyl acetate copolymer emulsion and the plasticizer, based on the total weight of the adhesive.

It is preferred that the aqueous dispersion type adhesive of the present invention further contains a viscosity modifier.

Specific examples of the viscosity modifier include those which are generally used as the viscosity modifier, for example:

nitrogen-containing substances such as urea, urea compound, and dicyandiamide, and

calcium hydroxide, calcium oxide, sodium carbonate, trisodium phosphate, diammonium hydrogen phosphate, borax, sodium fluoride, water glass, ammonia water, boric acid, vinylpyrrolidone based polymers, and alkylene oxide based polymers.

These viscosity modifiers may be used alone, and also plural kinds thereof may be used. In the present invention, the boric acid is most preferably as the viscosity modifier. The aqueous dispersion type adhesive of the present invention becomes more suited for high-speed coating by containing the boric acid. When an aqueous dispersion type adhesive is applied at high-speed using a nozzle coater, the aqueous dispersion type adhesive is more accurately ejected through the nozzle of the nozzle coater, and thus fouling of the nozzle is less likely to occur.

The aqueous dispersion type adhesive of the present invention can also appropriately contain additives such as tackifying resins (or tackifier resins), cross-linking agents, defoamers, thickeners, colorants, and antiseptics, optionally. There is no particular limitation on the mixing method of the additives. The various additives may be added to an aqueous medium when the ethylene-vinyl acetate based modified emulsion is produced, or may be added after producing the ethylene-vinyl acetate based modified emulsion.

Among the various additives, examples of the tackifying resin include a rosin based resin, a terpene resin, a terpene phenolic based resin, a cumarone indene resin, and a petroleum based hydrocarbon resin. Examples of the rosin based resin include rosin esters and rosin phenols.

The tackifying resin may be a commercially available tackifying resin and examples thereof include SUPERESTER E-730-55, SUPERESTER E-720, SUPERESTER 786-60, SUPERESTER E-650, SUPERESTER E-865, TAMANOL E-200, TAMANOL E-100, and AM-1002 (manufactured by Arakawa Chemical Industries, Ltd.); and HARIESTER DS-70E, HARIESTER SK-70D, HARIESTER SK-90D-55, HARIESTER SK-508H, HARIESTER SK-816E, and HARIESTER 822E (manufactured by Harima Chemicals Group, Inc.). Any name was indicated by the trade name.

According to the recent environmental awareness, it is preferred to use a toluene- and xylene-free type tackifying resin, or a solvent-free type tackifying resin. Examples of such tackifying resin include SUPERESTER E-865NT, SUPERESTER E-625NT, SUPERESTER NS-100H, SUPERESTER NS-121, and TAMANOL E-200NT (manufactured by Arakawa Chemical Industries, Ltd.); and HARIESTER SK-218NS, HARIESTER SK-323NS, HARIESTER SK-370N, HARIESTER SK-501NS, and HARIESTER SK-385NS (manufactured by Harima Chemicals Group, Inc.). Any name was indicated by the trade name.

Examples of the cross-linking agent include zinc acetate, zinc oxide, zirconium acetate, and ammonium zirconium carbonate. These cross-linking agents can be used alone or in combination.

The defoamer is roughly classified into a silicone based defoamer and a non-silicone based defoamer.

Examples of the silicone based defoamer include dimethylpolysiloxane, polyoxyalkylene-modified silicone, organic modified polysiloxane, and fluorosilicone.

Examples of the non-silicone based defoamer include:

defoamer based on fats and oils, such as castor oil, sesame oil, linseed oil, and animal or vegetable oil;

fatty acid based defoamers such as stearic acid, oleic acid, and palmitic acid;

fatty acid ester based defoamers such as isoamylstearic acid, diglycollauric acid, distearylsuccinic acid, distearic acid, sorbitanmonolauric acid, glycerin fatty acid ester, sorbitan fatty acid ester, polyoxyethylene sorbitan, monolauric acid butyl stearate, sucrose fatty acid ester, ethylacetic acid alkyl ester of sulfonated ricinoleic acid, and natural wax;

alcohol based defoamers such as polyoxyalkylene glycol and a derivative thereof, polyoxyalkylene alcohol hydrate, diamylphenoxyethanol, alkylene glycol, 3-heptanol, and 2-ethylhexanol;

ether based defoamers such as 3-heptyl cellosolve and nonyl cellosolve-3-heptyl carbitol;

phosphoric acid ester based defoamers such as tributyl phosphate, sodium octylphosphate, and tris(butoxyethyl)phosphate;

amine based defoamers such as diamylamine;

amide based defoamers such as polyalkylene amide, acylate polyamine, and dioctadecanoylpiperidine;

metal soap based defoamers such as aluminum stearate, calcium stearate, potassium oleate, and calcium salt of wool olein; and

sulfonic acid ester based defoamers such as sodium lauryl sulfonate and sodium dodecyl sulfonate.

The aqueous dispersion type adhesive according to the present invention preferably contains a non-silicone based defoamer as the defoamer. Use of the non-silicone based defoamer can suppress decrease in adhesion of the aqueous dispersion type adhesive according to the present invention.

The non-silicone based defoamer is preferably an alcohol based defoamer, and particularly preferably an ethylene glycol based defoamer. NOPCO NDW (manufactured by SAN NOPCO LIMITED) is commercially available as the ethylene glycol based defoamer.

Examples of “thickener” include:

natural polymer based thickeners such as gelatin, casein, alginic acid, propylene glycol alginate, triethanolamine alginate, ammonium alginate, sodium alginate, guar gum, gellan gum, xanthan gum, welangum, ethyl cellulose, hydroxyethyl cellulose, methyl cellulose, carboxymethyl cellulose, hydroxypropyl cellulose, and hydroxypropylmethyl cellulose;

polyvinyl based thickeners such as polyvinyl alcohol and polyvinyl benzyl ether copolymer;

poly(meth)acrylic acid based thickeners such as sodium polyacrylate, acrylic acid-(meth)acrylic acid ester copolymer, sodium polymethacrylate, methacrylic acid-(meth)acrylic acid ester copolymer, modified polyacrylic acid sulfonic acid salt, modified polymethacrylic acid sulfonic acid salt, styrene-acrylic acid copolymer, styrene-acrylic acid-(meth)acrylic acid ester copolymer, styrene-methacrylic acid copolymer, and styrene-methacrylic acid-(meth)acrylic acid ester copolymer;

polyether based thickeners such as pluronic polyether, polyether dialkyl ester, modified polyetherurethane, polyether dialkyl ether, and modified polyetherepoxy;

itaconic acid based thickeners such as polyitaconic acid, itaconic acid-(meth)acrylic acid ester copolymer, itaconic acid-maleic acid copolymer, itaconic acid-acrylic acid copolymer, and itaconic acid-methacrylic acid copolymer;

maleic anhydride based thickeners such as maleic anhydride-(meth)acrylic acid ester copolymer, maleic anhydride-acrylonitrile copolymer, maleic anhydride-vinyl acetate copolymer, and partial ester of vinylmethylether-maleic anhydride copolymer; and

higher fatty acid amide based thickeners.

Examples of “colorant” include:

insoluble azo pigments such as fast yellow, diazo yellow, diazo orange, and naphthol red;

phthalocyanine based pigments such as copper phthalocyanine;

dye lakes such as fanal lake, tannin lake, and katanol;

isoindolino based pigments such as isoindolino yellow-greenish and isoindolino yellow-reddish;

quinacridone based pigments;

perylene based pigments such as perylene scarlet and perylenemaroon; and

inorganic based pigments such as carbon black, white lead, red lead, chrome yellow, vermilion, ultramarine, cobalt oxide, titanium dioxide, titanium yellow, strontium chromate, molybdenum red, molybdenum white, iron black, lithopone, emerald green, Guignet's green, and cobalt blue.

The viscosity of the aqueous dispersion type adhesive of the present invention is adjusted within a range from 10 to 3,000 mPa·s by containing the above-mentioned components. The viscosity is measured at 30° C. using an SB type rotational viscometer (spindle No. 4) and is preferably from 100 to 1,000 mPa·s, and particularly preferably from 200 to 800 mPa·s. When the viscosity is within the above range, the obtained aqueous dispersion type adhesive of the present invention is excellent in balance between adhesion and coating suitability.

Examples of the method of applying the aqueous dispersion type adhesive according to the present invention include general methods such as a wheel method, a blade method, a mount method, a nozzle method, and a spray method. Taking account of accurate and rapid bonding between an adherend and a base material, a nozzle method of applying an aqueous dispersion type adhesive using a nozzle coater is preferable. When the aqueous dispersion type adhesive of the present invention is applied by a nozzle coater, fouling of the nozzle is inhibited.

As a matter of course, the aqueous dispersion type adhesive may be applied to an adherend or a base material by manual labor using a brush or a spatula, in place of the coater.

The aqueous dispersion type adhesive of the present invention is widely used, for example, in woodworkings, electronic components, building materials, sanitary materials, and paper products, and can be preferably used for producing paper products, and is also useful as an aqueous dispersion type adhesive for paper products.

The paper product according to the present invention refers to a paper product produced by using the above aqueous dispersion type adhesive. There is no particular limitation on the kind of the paper product, as long as the paper product is produced by using the above aqueous dispersion type adhesive, and specific examples thereof include bookbindings, labels, packaging containers, calendars, corrugated cardboards, and cartons. Taking account of characteristics of the aqueous dispersion type adhesive of the present invention, a packaging container is particularly effective as the paper product of the present invention.

Examples of the packaging container include containers produced by bonding between a paper and a paper, or bonding between a paper and other base materials (a metal foil, a plastic film, or a woody material), like containers of confectioneries, dairy products, drugs, and cigarettes. The other base material is preferably a metal foil, and more preferably an aluminum foil, a copper foil, a tin foil, a gold foil, an aluminum bronze foil, a brass foil, a platinum foil, a stainless steel foil, a titanium alloy, and a nickel alloy foil.

Therefore, the aqueous dispersion type adhesive of the present invention is excellent in adhesion between papers and adhesion between a paper and aluminum, and thus the paper product according to the present invention is preferably a packaging container and bookbinding, and particularly preferably a packaging container.

Main embodiments of the present invention are shown below.

1. An aqueous dispersion type adhesive including a modified ethylene-vinyl acetate copolymer based emulsion and a plasticizer, wherein the plasticizer contains an acetyl group-containing compound.

2. The aqueous dispersion type adhesive according to the above 1, wherein the acetyl group-containing compound contains triacetin.

3. The aqueous dispersion type adhesive according to the above 1 or 2, wherein the plasticizer further contains a benzoic acid ester.

4. The aqueous dispersion type adhesive according to any one of the above 1 to 3, wherein the modified ethylene-vinyl acetate copolymer based emulsion contains a modification in which a C═O-containing functional group is attached to an ethylene-vinyl acetate copolymer.

5. The aqueous dispersion type adhesive according to any one of the above 1 to 4, wherein the modified ethylene-vinyl acetate copolymer based emulsion contains a modification in which a carboxyl group is attached to an ethylene-vinyl acetate copolymer.

6. The aqueous dispersion type adhesive according to any one of the above 1 to 5, wherein the ethylene-vinyl acetate based modified emulsion has a glass transition temperature of 10° C. or lower.

7. The aqueous dispersion type adhesive according to any one of the above 1 to 6, the adhesive is used for paper processing.

8. A paper product obtainable by using the aqueous dispersion type adhesive according to any one of the above 1 to 7.

### EXAMPLES

The present invention will be described below by way of Examples and Comparative Examples, but these examples are exemplary of the invention and are not to be considered as limiting.

First, the following components were prepared as components of aqueous dispersion type adhesives. Parts are by weight unless otherwise specified.

(A) Ethylene-Vinyl Acetate Based Modified Emulsion

(A1) Ethylene-vinyl acetate based modified emulsion (SUMIKAFLEX 5456 (trade name), Sumika Chemtex Company, Limited, carboxyl group-containing emulsion having a glass transition temperature of 2° C.)

(A2) Ethylene-vinyl acetate based modified emulsion (POLYSOL AD21 (trade name), Showa Denko K.K., carboxyl group-containing emulsion having a glass transition temperature of 4° C.)

(A3) Ethylene-vinyl acetate based modified emulsion (POLYSOL AD 11 (trade name), Showa Denko K.K., carboxyl group-containing emulsion having a glass transition temperature of 9° C.)

(A′4) Ethylene-vinyl acetate emulsion (SUMIKAFLEX 5408 (trade name), Sumika Chemtex Co., Ltd., glass transition temperature of −22° C.)

(A′5) Ethylene-vinyl acetate emulsion (POLYSOL AD 10 (trade name) Showa Denko K.K., glass transition temperature of 13° C.)

(A′6) Ethylene-vinyl acetate emulsion (SUMIKAFLEX 5450 (trade name), Sumika Chemtex Co., Ltd., glass transition temperature of 3° C.)

(A′7) Vinyl acetate emulsion (125-2828 (trade name), Henkel Japan, Ltd., glass transition temperature of 27° C.)

(B) Plasticizer

(B1) Triacetin (triacetin, Wako Pure Chemicals Industries, Ltd.)

(B2) ATBC (o-tributyl acetylcitrate, Wako Pure Chemicals Industries, Ltd.)

(B′3) Benzoic acid ester (Benzoflex 9-88 (trade name), Velsicol Chemical Corporation)

(B′4) Glycerin (Wako Pure Chemicals Industries, Ltd.)

### [Viscosity Modifier]

Boric acid (Wako Pure Chemicals Industries, Ltd.)

### [Defoamer]

Non-silicone (ethylene glycol) based defoamer (NOPCO-NDW (trade name), SAN NOPCO LIMITED)

<Production of Aqueous Dispersion Type Adhesive>

### Example 1

In a flask equipped with a stirrer, 150 parts of water and 85 parts (in terms of solid content) of an ethylene-vinyl acetate based modified emulsion were charged and stirred at about 25° C. (room temperature) for 30 hours, and then 15 parts (in terms of solid content) of a plasticizer was added, followed by further stirring for 30 minutes. Thereafter, 0.1 part (in terms of solid content) of boric acid was mixed to obtain 250.1 parts of a preparation. After adding 0.8 part (in terms of solid content) of a defoamer to the preparation and further stirring for 30 minutes, an aqueous dispersion type adhesive was obtained.

### Examples 2 to 8 and Comparative Examples 1 to 5

According to the formulations shown in Table 1, aqueous dispersion type adhesives were produced. The methods for producing the aqueous dispersion type adhesives are analogous to the method of Example 1.

TABLE 1

| | | Examples | | | | | | | | Comparative Examples | | | | |
|---|---|---|---|---|---|---|---|---|---|---|---|---|---|---|
| | Components | 1 | 2 | 3 | 4 | 5 | 6 | 7 | 8 | 1 | 2 | 3 | 4 | 5 |
| (A) | (A1) | 85 | | | 85 | | | | | | | | | 85 |
| | (A2) | | 85 | | | 85 | | 85 | 85 | | | | | |
| | (A3) | | | 85 | | | 85 | | | | | | | |
| | (A′4) | | | | | | | | | 85 | | | | |
| | (A′5) | | | | | | | | | | 85 | | | |
| | (A′6) | | | | | | | | | | | 85 | | |
| | (A′7) | | | | | | | | | | | | 85 | |
| (B) | (B1) | 15 | 15 | 15 | 2 | 2 | 2 | 6 | | 15 | 15 | 15 | 15 | |
| | (B2) | | | | | | | | 15 | | | | | |
| | (B′3) | | | | 13 | 13 | 13 | 9 | | | | | | |
| | (B′4) | | | | | | | | | | | | | 15 |
| Others | Defoamer | 0.8 | 0.8 | 0.8 | 0.8 | 0.8 | 0.8 | 0.8 | 0.8 | 0.8 | 0.8 | 0.8 | 0.8 | 0.8 |
| | Viscosity modifier | 0.1 | 0.1 | 0.1 | 0.1 | 0.1 | 0.1 | 0.1 | 0.1 | 0.1 | 0.1 | 0.1 | 0.1 | 0.1 |

With respect to the aqueous dispersion type adhesives of Examples and Comparative Examples, adhesion and coating suitability (or applicability) were evaluated. The procedure for evaluation test, and evaluation criteria are shown below.

Evaluation of Adhesion

### 1. Peel Test (Paper/Paper)

Using a bar coater No. 14 (Coating Tester Kogyo Corporation), each of the aqueous dispersion type adhesives of Examples and Comparative Examples was applied to a commercially available paper with white background in a coating amount of about 20 g/m² (the coating amount is the total amount of solid component and water) and then laminated with another commercially available paper with white background. After drying the adhesive at room temperature of 23° C., peel strength of the adhesive was measured.

The peel test will be described in detail below.

First, the laminate of the paper with white background on which the adhesive was applied was cut into pieces to obtain test pieces (measuring 25 mm in width and 50 mm in length) for the measurement of peel strength. Using TENSILON®250 (trade name) (ORIENTEC Co., Ltd.), the peel strength was measured at a peeling speed of 300 mm/minute.

(Evaluation Criteria)

A: Peel strength is 300 gf/25 mm or more (material failure occurs on the entire peeling surface).

B: Peel strength is 200 gf/25 mm or more and less than 300 gf/25 mm (material failure occurs on the most peeling surface).

C: Peel strength is 100 gf/25 mm or more and less than 200 gf/25 mm (material failure occurs on partial peeling surface). D: Peel strength is less than 100 gf/25 mm (interfacial peeling occurs on the peeling surface).

### 2. Peel Test (Paper/Aluminum Deposited Paper)

Using a bar coater No. 20 (Coating Tester Kogyo Corporation), each of the aqueous dispersion type adhesives of Examples and Comparative Examples was applied to a commercially available aluminum deposited paper in a coating amount of about 30 g/m² (the coating amount is the total amount of solid component and water) and then bonded (or laminated) with a commercially available paper having white background. After drying the adhesive at room temperature of 23° C., peel strength of the adhesive was measured.

The peel test will be described in detail below.

First, the laminate of the aluminum deposited paper on which the adhesive was applied was cut into pieces to obtain test pieces (measuring 25 mm in width and 50 mm in length) for the measurement of peel strength. Using TENSILON®250 (trade name) (ORIENTEC Co., Ltd.), the peel strength was measured at a peeling speed of 300 mm/minute.

(Evaluation Criteria)

A: Peel strength is 180 gf/25 mm or more (material failure occurs on the entire peeling surface).

B: Peel strength is 130 gf/25 mm or more and less than 180 gf/25 mm (material failure occurs on the most peeling surface).

C: Peel strength is 100 gf/25 mm or more and less than 130 gf/25 mm (material failure occurs on partial peeling surface). D: Peel strength is less than 100 gf/25 mm (interfacial peeling occurs on the peeling surface).

Evaluation of Coating Suitability

### Nozzle Coating Test

Each of the aqueous dispersion type adhesives of Examples and Comparative Examples was continuously ejected by a HHS nozzle coater (VD-504S (trade name) gun type-Bauner hhs Glmb) for 2 hours, and then dots of the adhesive ejected through a nozzle and fouling of the nozzle were evaluated.

When the adhesive was ejected, the nozzle coater was operated under a pressure of 6.0 Bar at a shot speed of 4,000 dots/minute. The temperature upon measurement was about 23° C. (room temperature).

(Evaluation Criteria)

A: Fouling of a nozzle tip is less likely to occur, and an adhesive is ejected in parallel.

B: Although slight fouling of a nozzle tip occurs, an adhesive is ejected in parallel.

C: Since fouling of a nozzle tip occurs, an adhesive is not normally ejected.

With respect to the respective aqueous dispersion type adhesives of Examples and Comparative Examples, adhesion and coating suitability were evaluated by the above procedures. The results are shown in Table 2.

TABLE 2

| | Examples | | | | | | | | Comparative Examples | | | | |
|---|---|---|---|---|---|---|---|---|---|---|---|---|---|
| | 1 | 2 | 3 | 4 | 5 | 6 | 7 | 8 | 1 | 2 | 3 | 4 | 5 |
| Peel strength | 300 | 310 | 320 | 310 | 300 | 300 | 320 | 310 | 110 | 220 | 230 | 150 | 210 |
| (Paper/Paper)^{a)} | | | | | | | | | | | | | |
| Evaluation | A | A | A | A | A | A | A | A | C | B | B | C | B |
| Peel strength | 190 | 210 | 180 | 180 | 200 | 190 | 210 | 200 | 80 | 60 | 60 | 50 | 70 |
| (Paper/Aluminum)^{a)} | | | | | | | | | | | | | |
| Evaluation | A | A | A | A | A | A | A | A | D | D | D | D | D |
| Coating suitability | A | A | A | A | A | A | A | A | A | A | A | B | B |

^{a)}gf/25 mm

As shown in Table 1 and Table 2, the aqueous dispersion type adhesives of Examples contain an ethylene-vinyl acetate based modified emulsion having a carboxyl group and contain an acetyl group-containing compound as a plasticizer, and are therefore excellent in both adhesion and coating suitability.

In contrast, the aqueous dispersion type adhesives of Comparative Examples do not contain an ethylene-vinyl acetate based modified emulsion or an acetyl group-containing compound, and are therefore inferior in adhesion and coating suitability as compared with the aqueous dispersion type adhesive of Examples.

As is apparent from Table 2, there arises a remarkable difference in adhesion between a paper and aluminum, between the aqueous dispersion type adhesives of Examples and the aqueous dispersion type adhesives of Comparative Examples.

As mentioned above, it was provided that the aqueous dispersion type adhesive is excellent in adhesion and coating suitability by containing two components of an ethylene-vinyl acetate based modified emulsion and an acetyl group-containing compound. The aqueous dispersion type adhesive of the present invention enables high-speed coating using a nozzle coater and is therefore suited for efficiently producing a paper product.

### INDUSTRIAL APPLICABILITY

The present invention can provide an aqueous dispersion type adhesive, and a paper product obtainable by applying the aqueous dispersion type adhesive. The aqueous dispersion type adhesive according to the present invention is useful for producing paper products and is also particularly excellent in adhesion between papers and metal foils (for example, aluminum, tin, copper, stainless steel, titanium, nickel, and platinum), and thus it is useful as wrapping papers of premium confectioneries, and packaging containers of confectioneries, dairy products, drugs, and cigarettes.

1: An aqueous dispersion type adhesive comprising a modified ethylene-vinyl acetate copolymer based emulsion and a plasticizer, wherein the plasticizer contains an acetyl group-containing compound.

2: The aqueous dispersion type adhesive according to claim 1, wherein the acetyl group-containing compound contains triacetin.

3: The aqueous dispersion type adhesive according to claim 1, wherein the modified ethylene-vinyl acetate copolymer contains a modification in which a C═O-containing functional group is attached to an ethylene-vinyl acetate copolymer.

4: The aqueous dispersion type adhesive according to claim 1, wherein the modified ethylene-vinyl acetate copolymer based emulsion contains a modification in which a carboxyl group is attached to an ethylene-vinyl acetate copolymer.

5: The aqueous dispersion type adhesive according to claim 1, wherein the modified ethylene-vinyl acetate copolymer has a glass transition temperature of 10° C. or lower.

6. (canceled)

7: A paper product comprising the aqueous dispersion type adhesive of claim 1.
